(19) United States
(12) Patent Application Publication
(10) Pub. No.: US 2002/0055912 A1
(43) Pub. Date: May 9, 2002

(54) Network and method for facilitating on-line privacy

(76) Inventor: Byron Buck, Washington, DC (US)

Correspondence Address: Richard C. Litman, LITMAN LAW OFFICES, LTD., P.O. Box 15035, Arlington, VA, 22215, US

(21) Appl. No.: 09/982,019

(22) Filed: Oct. 19, 2001

Related U.S. Application Data
(60) Provisional application No. 60/241,749, filed on Oct. 20, 2000.

(51) Int. Cl. H04K 1/00

(52) U.S. Cl. 705/76; 713/182

(57) ABSTRACT

A network consisting of member users and member vendors and a method of insuring the privacy of those members. The network, known as the e-Privacy Network, allows user members to browse the Web with the security of having a consent/permission relationship, known as an e-Privacy contract, when browsing the sites of member vendors. Users are protected by cookie-removal protection when browsing a non-member site. Because user members are protected by the e-privacy contract, they are confident in allowing their personally identifiable information, known as an e-profile, to be submitted to member vendors. The e-cookie software permits Web sites to collect non-identifiable information about the member users that may result in better targeted advertisements, offers, deals, etc. for user, as well as incentives for the submission of e-profile information. A method and means for monitoring or auditing internet usage is also disclosed.

### CROSS-REFERENCE TO RELATED APPLICATION

This application claims the benefit of U.S. Provisional Patent Application Ser. No. 60/241,749, filed Oct. 20, 2000.

### BACKGROUND OF THE INVENTION

1. Field of the Invention

The present invention relates to a consent-based personal information management network having member users and member vendors and a method of contractually guaranteeing a user's privacy in dealings with vendors.

2. Description of Related Art

An attempt to address the privacy issue is taught in U.S. Pat. No. 5,987,440 to Kevin O'Neil et al. A software system on the Internet creates a virtual private network giving individuals the ability to enter, secure, and control personal information.

Another attempt to deal with invasions of privacy is taught in European Patent 951,158, published on Oct. 20, 1999, which teaches a system and method in which the user controls the use of cookies.

Security for authorization, use, and authenticity, as well as filtering systems, have been developed in response to privacy invasions. These systems and methods are taught by U.S. Pat. Nos. 5,848,233, issued on Dec. 8, 1998 to Sanjay Radia et al., 5,878,417, issued on Mar. 2, 1999 to Wayne Baldwin et al., 5,884,033, issued on Mar. 16, 1999 to William Duvall et al., 5,974,549, issued on Oct. 26, 1999 to Gilad Golan, 6,073,242, issued on Jun. 6, 2000 to Ann Hardy et al., 6,108,786, issued on Aug. 22, 2000 to Kenneth Knowlson, and 6,119,227, issued on Sep. 12, 2000 to Wenbo Mao.

U.S. Pat. Nos. 5,848,412, issued on Dec. 8, 1998 to Bruce Rowland, et al., and 6,005,939, issued on Dec. 21, 1999 to Keith Fortenberry et al., teach user-controlled information disclosures for identification to allow access to a Web site or controlled portion thereof.

Many of these methods to enhance privacy or security involve the release of personal information. However some methods and systems for gathering consumer information do so without a focus on privacy or security. For example, methods and systems to provide easier shopping experiences or personalized Web pages are taught in U.S. Pat. Nos. 5,987,466, issued on Nov. 16, 1999 to Timothy Greer et al., 6,085,229, issued on Jul. 4, 2000 to Gary Newman et al., and 6,092,053, issued on Jul. 18, 2000 to Brian Boesch et al.

Other methods and systems for obtaining user information are known. U.S. Pat. No. 6,112,240, issued on Aug. 29, 2000 to Michael Pogue et al., teaches a tracker tag in the code of a Web page for initiating a client information tracking program. U.S. Pat. No. 5,848,396, issued on Dec. 8, 1998 to Thomas Gerace, teaches a method and apparatus for creating user profiles based on recording computer activity of users and targeting advertisements based on user preferences.

None of the above inventions and patents, taken either singly or in combination, is seen to describe the instant invention as claimed.

### SUMMARY OF THE INVENTION

The invention is related to a network consisting of member users and member vendors and a method of insuring the privacy of those members. The network, known as the e-Privacy Network, allows user members to browse the Web with the security of having a privacy contract (or consent\permission relationship), known as an e-Privacy contract, when browsing the sites of member vendors. Users are protected by cookie-removal protection when browsing a non-member site.

Because user members are protected by an e-Privacy contract, they are confident in submitting or allowing their personally identifiable information, known as an e-profile, to be submitted to member vendors. By protecting personally identifiable information in an e-profile and allowing Web sites to collect non-identifiable information (general information), user members receive better targeted advertisements, offers, deals, etc., as well as incentives for the submission of e-profile information.

When a user of the Web enters a site, the site often sends a cookie, an electronically-created file for tracking a user with a unique identifier for that user. The user may have the option of accepting or refusing the cookie, or the user's browser may automatically accept the cookie (depending on how the browser is set, if it can be adjusted at all). Acceptance of the cookie may be a requirement for uninhibited browsing, i.e. some sites will not let a user browse or have access without accepting the cookie. The cookie is usually placed on the hard drive of the user's personal computer and retrieved by the site so that it “recognizes” the return of the user. When used with browsing information, i.e. what the user did while on that site, a profile can be established. Finally, when that user buys something, the site knows the personal identity of that user and can equate them with the browsing habits (for its site only) of that user. Many users consider this to be an invasion of privacy.

For example, a user enters a site that sells books, accepts a cookie, and searches for pornographic material. The user leaves the site and returns at some later date (the site recognizes the cookie and knows that the person who earlier searched for pornographic material is back) and buys a mystery book, giving a name and address. The identity is now matched with all of the browsing history and may result in embarrassing mail or other invasions of privacy. It is understandable that users do not want to accept cookies. However, their acceptance may be an inevitable part of searching and browsing Web sites, as noted above.

According to the present invention, either through e-Privacy software resident on the user's personal computer or on the e-Privacy Web site or any other feasible means, the cookie is accepted. It is then determined if the vendor site is a member of the e-Privacy Network. If the vendor site is a member, the software places a member e-cookie on the hard drive of the user allowing the Web site to collect non-identifiable information (also referred to as general information) about the user member, and, when required, personal identifiable information about the user, known as the user's e-profile. The present invention also contemplates other methods of making available the general information and the personal identifiable information to member vendors, e.g. through forwarding a member e-cookie to the vendor site containing or allowing it to collect information.

It is noted that the order of the process is not critical and it can be varied, for example the software may determine if the vendor is a member of the network before the acceptance of the cookie. This order change may allow the software to immediately treat cookies differently depending on their source. If the site is not a member of the e-Privacy Network, the cookie sent by the site is removed or hidden after the user completes the session on the site. The non-member site will have information as to the session, for example that the user searched for mystery books, but will not recognize the user when they return because there will be no cookie identifying the user. The non-member site may be sent a non-member e-cookie or, alternatively, some type of communication. The non-member e-cookie, which will be generated by the software but will not identify the user to the vendor (there may be user identification means for the e-Privacy Network), will tell the non-member site that its cookie has been removed and inform it that its cookies will continue to be removed unless it affirms the e-Privacy contract and joins the e-Privacy Network. The non-member e-cookie may state that their cookie has been returned (without any identifying information) and invites the non-member Web site to become a member of the e-Privacy Network.

It is important that the e-Privacy Network be aware of non-member e-cookies sent to non-members so it can follow up if the non-member e-cookies do not result in the non-member joining the network. This awareness will be automatic if the software is resident on its site. If the software is resident on the user's personal computer, messages sent from the software to the network or files that are created by the software and read by the network when the user visits the network site may be ways of notifying the network of non-member e-cookies sent.

Those who affirm the consent/permission relationship (e-privacy contract), either initially and are immediately members of the e-Privacy Network or after receiving a non-member e-cookie, will recognize member e-cookies when a user enters their site. The member e-cookie will enable the site to collect non-identifiable information about the user and, when needed, to obtain a user's e-profile information. The member e-cookie includes a means, e.g. a “key”, such that when the site recognizes the user as a member of the e-privacy network, it will be sent a summary of the e-profile (the Consent profile). This request may occur during the user's session, i.e. in real-time, or at some later time.

After receiving the user's Consent profile, the member vendor may choose to request additional e-profile information. Users are encouraged to respond to these vendor information requests and are often provided incentives to do so by the vendor member. The response to these requests may be in the form of updating their e-profile information or directly responding to the vendor.

The e-Privacy Network provides confidence to the consumer to accept cookies, or allow the software to accept cookies, and to provide personal information to complete their e-profile. The basis for this confidence is the consent/permission relationship created by the e-Privacy contract. The e-Privacy contract affirms that a Web site will respect the preferences of the user with respect to his personally-identifiable information as summarized in the Consent profile and contained in the e-profile. The terms state that the e-Privacy Network user will see any e-profile information collected about that user (the e-Privacy Network will maintain an audit trail), that the user will from time to time to edit the e-profile information, that the Web site will share this information only with the permission of the user, that the user may “opt out” and the Web site will permanently erase any e-profile information collected, and that the Web site will use reasonable means to protect the security of the e-profile information.

The e-Privacy contract is affirmed by member vendors (this affirmation is a condition of becoming a member), usually by digital certification, and forwarded to the e-Privacy Web site. The e-Privacy Web site updates the list of vendor members based on the receipt of this new contract. Additionally, the e-Privacy software must be updated to recognize any new vendors who join the network. Depending on the location of the software, the software portion of the site is updated or the software on a user's computer is updated. All Web site members of the e-Privacy Network will be listed and described through the software. Software on the user's computer may be updated the next time that user logs onto the e-Privacy site, either automatically or by making the updated software available for download. The e-Privacy Network may send a notification, e.g. an e-mail, to the user to indicate that new software is available for download. As discussed above, e-profiles are prepared for delivery to member vendors with each vendor member receiving a Consent Profile when a user accesses a site, and then receiving the personally-identifiable information according to the preferences of the user member. The user member has previously defined and selected the amount of information that they will allow to be sent to specific vendors, e.g. the user may choose to provide greater information to sites selling sports-related goods than to sites selling toys. E-profiles are stored on the e-Privacy software, i.e. on the individual user's computer or the e-Privacy site, and are generated by Web-based forms or any other known method for obtaining personal data.

Accordingly, it is a principal object of the invention to allow a user to visit Web sites with the confidence that their privacy will be maintained.

It is another object of the invention to encourage vendors to join a network through which they are contractually obligated to maintain the privacy of users.

It is a further object of the invention to collect personal data from individual users, which they are willing to share because their privacy is guaranteed.

Still another object of the invention is to allow uninhibited browsing by providing software to accept cookies.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is a block diagram contrasting normal, unprotected browsing with protected browsing utilizing the present invention and having e-Privacy software on a personal computer.

FIG. 1B is a block diagram contrasting normal, unprotected browsing with protected browsing utilizing the present invention and having e-Privacy software used through the e-Privacy Web site.

FIG. 2A is a block diagram of the decision process related to the handling of cookies and the forwarding and handling of e-cookies.

FIG. 2B is a block diagram of the decision process for monitoring Internet usage.

FIG. 3 is a block diagram of the forwarding and handling of member e-cookies.

FIG. 4 is a block diagram of the forwarding and handling of non-member e-cookies.

FIG. 5A is a schematic representation of the creation and use of e-profiles.

FIG. 5B is a continuation of the representation of FIG. 5A.

FIG. 6 is a schematic representation of the creation and use of vendor profiles.

Similar reference characters denote corresponding features consistently throughout the attached drawings.

### DETAILED DESCRIPTION OF THE PREFERRED EMBODIMENTS

The present invention relates to a method and system for guaranteeing a computer user privacy and control of the use of their own information.

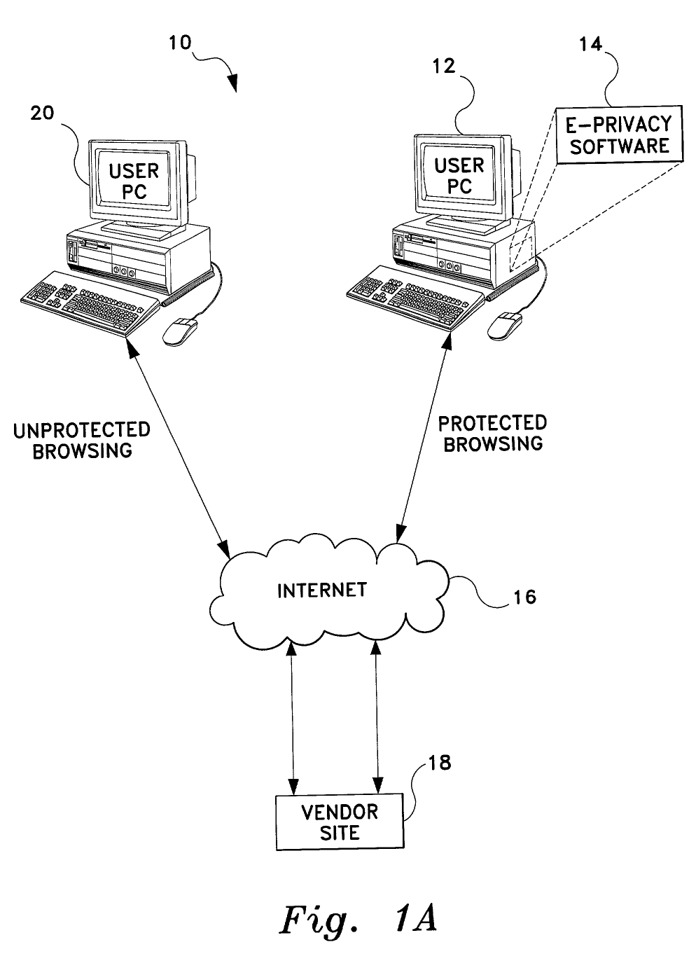

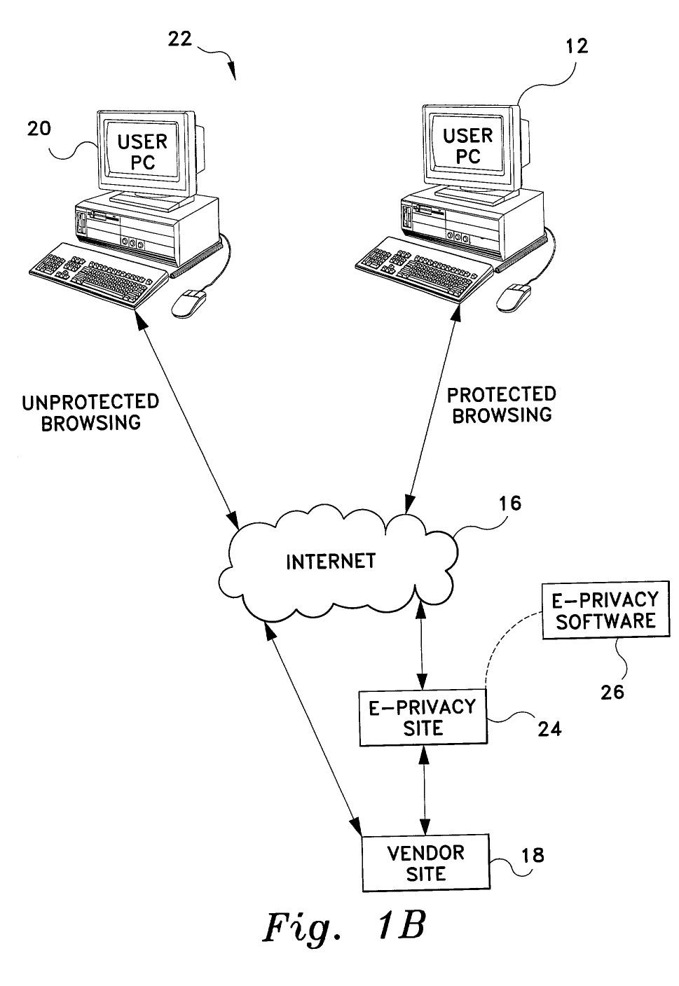

FIG. 1A is a representation of a first embodiment of protected browsing 10. The right side of the figure shows a personal computer 12 of a user-member having e-Privacy software 14 on it. The user computer 12 contacts the Internet 16 and the site of a vendor 18. It is noted that the invention contemplates any type of site, e.g. vendor, government, information, etc. It is most likely that the site of a vendor will be the target of the instant invention. However, any site which seeks to obtain information and send cookies to a user may be targeted by the instant invention.

The e-Privacy software 14, the method in which it functions will be described in detail below, allows the user-member to browse with protection, either browsing with e-cookie protection or browsing with an e-Privacy contract. In contrast, the user of PC 20, shown on the left side of FIG. 1A, browses unprotected and is subject to the invasions of privacy inherent with cookies because there is no e-Privacy software.

A similar scenario is shown in the second embodiment of protected browsing 22, as shown in FIG. 1B. In this case, the PC of the user member 12 does not include e-Privacy software 14, but connects to a vendor site 18 and utilizes e-Privacy software 26 on the e-Privacy site 24. As in FIG. 1A, the PC of the non-member 20 is subject to the invasions of privacy which are eliminated by the use of the present software 26.

It is noted that the location of the software, on the e-Privacy site 24 or the user's PC 12, is not critical in the operation of the software and the method of protecting the user from privacy invasions. It is contemplated that a portion of the software, or one software set of instructions, may be located on the PC 12, i.e. to control the handling of cookies, and that another portion, or set of instructions, may be located on the e-Privacy site, i.e. to control the creation and handling of e-profiles and vendor requests, discussed in more detail below. It is noted that any combination of locations of the software, or portions thereof, is within the scope of the present invention.

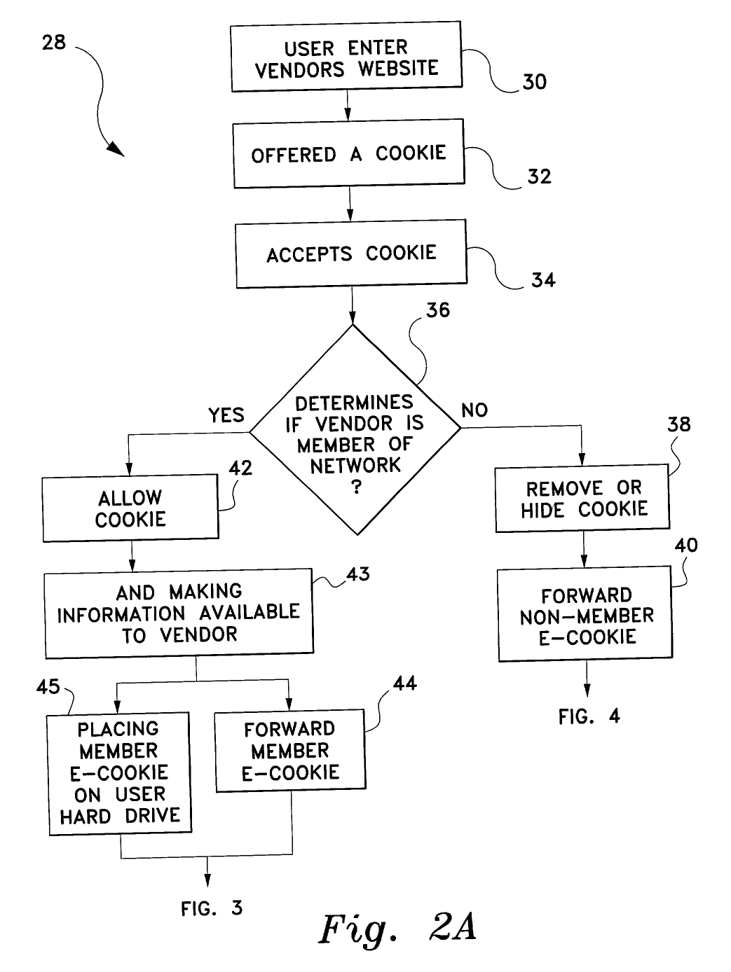

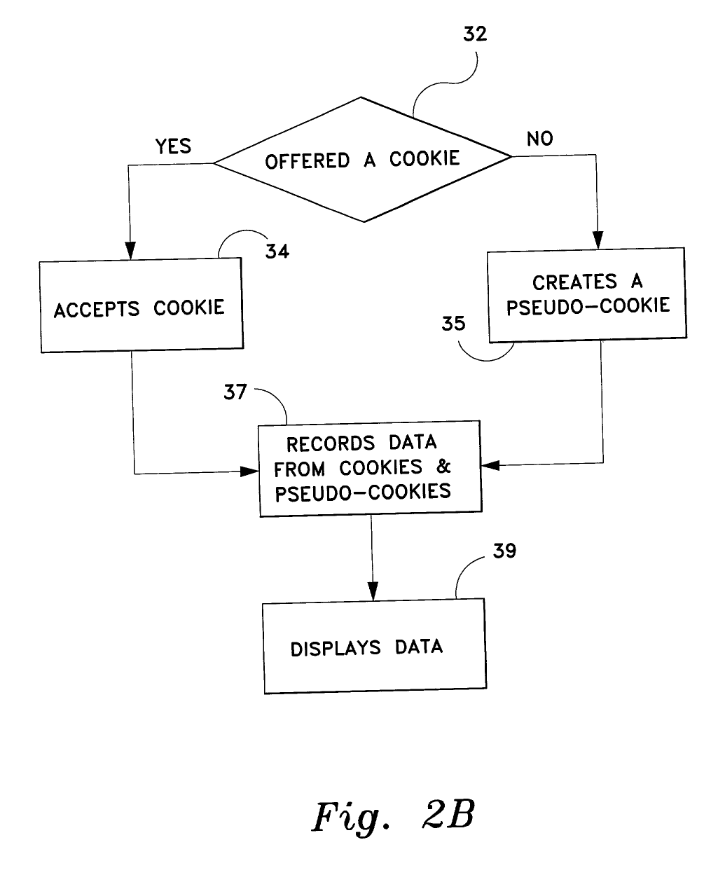

The software 14 or 26, regardless of its location allows a user to accept a cookie and enjoy uninhibited browsing. The process of protected browsing 28 is depicted in FIG. 2A. The user enters the Web site of a vendor 30 and the site requests to send a cookie 32. Depending on the configuration of the user's browser, the user may or may not see this request 32. In the latter case, the cookie is automatically sent. The software 14 or 26 accepts the cookie 34, which may be necessary for uninhibited browsing. The software can also aid in the monitoring of Internet usage, as discussed below with reference to FIG. 2B.

The software makes an evaluation to determine if the vendor sending the cookie is a member of the e-Privacy Network 36, i.e. has signed a contract affirming the user's privacy. This evaluation, a process of verification and authentication, occurs during each session to affirm that an e-Privacy contract exists. The result of this evaluation 36 determines the disposition of the cookie. It is noted that this evaluation 36 may occur earlier in the process 28, i.e. before the cookie is accepted 34 or even offered 32. However, the timing of the recognition of the identity of membership status of the vendor will not change the handling of the cookie and the forwarding of e-cookies discussed below.

The right leg of the decision block 36 illustrates browsing with e-cookie protection. If the vendor is determined to be a non-member by the verification and authentication process, the cookie sent by that vendor is removed or hidden, i.e. stored under a different name, 38 and a non-member e-cookie is forwarded 40. The removal or hiding of the cookie 38 and forwarding the non-member e-cookie 40 may take place during or after the user's session.

However, it should be noted that for unhindered browsing, these actions, designed to limit the site's ability to collect information about a user and to encourage the site to join the e-Privacy Network, may be better taken after the session. The invention contemplates that these actions will be taken when the user closes the browser or, in the case of always-on connections, at certain times.

It is further noted that there may be some instances where the user does not want the cookie sent by a non-member site to be removed or hidden, i.e. does not want the e-cookie protection. For example, if the cookie “remembers” login information for banks or other sites, is an information site, or the user does not want to ask for an e-Privacy contract, the user will not want the cookie to be deleted and will be able to select normal browsing based on their preference (which will be expressed through queries from the e-Privacy Network or a list of preferences of each user).

If, on the other hand, the vendor is authenticated as a member of the network, i.e. that vendor has signed a privacy contract, the user is again protected, i.e. browsing with an e-Privacy contract (seen in the left leg of FIG. 2A). It is noted that the membership status may have been attained by the process described above (the right leg of FIG. 2A) or the initial negotiation between the site and the e-Privacy Network at the outset of the privacy method. Alternatively, in response to advertising, the vendor may have initially visited the e-Privacy site, and downloaded and executed a contract to become a member vendor.

The authentication of the vendor to be a member affirms the e-Privacy contract and verifies that it is still in force and the vendor is aware of its responsibilities. The cookie is accepted 42 and will not be removed or hidden. The information is made available to the vendor 43, either by forwarding a member e-cookie 44 or placing an e-cookie on the user's hard drive 45.

As seen in FIG. 2B, the invention contemplates that the software monitors Internet usage by keeping track of all cookies (an auditing process that copies the domain name from the cookie or any other method of recording the presence of cookies) sent by Web sites. The software instructions shown in FIG. 2B may take place within the instructions of FIG. 2A. As in FIG. 2A, the vendor site offers a cookie 32. Because some sites do not have cookies, it is not definite that a cookie will be offered (thus, there is a decision box in FIG. 2B). In FIG. 2A, the offering of the cookie was a certainty (for purposes of demonstrating protected browsing and the disposition of cookies).

If the cookie is offered, the cookie is accepted 34, as in FIG. 2. If the site does not send a cookie, a pseudo-cookie, identifying the site, is created 35. The data on the cookies and pseudo-cookies is recorded 37. By maintaining a record of all cookies and pseudo-cookies, there is a record of all sites and pages (because the cookie keeps track of all pages visited on a site) visited by that computer. The software can cause a list of all sites and pages visited to be displayed 39. This auditing and monitoring feature can be used by parents in regard to the usage of children or employers regarding the usage of employees.

It is noted that it may be advantageous for the e-Privacy Network to be aware of those sites for which pseudo-cookies must be created. This awareness will allow the e-Privacy site to contact those sites (through e-mail, etc.) to offer them an opportunity to join the e-Privacy Network. Therefore, the software will be able to communicate the necessity of creating pseudo-cookies, e.g. by creating additional copies and forwarding them to another portion of the e-Privacy site or a portion of the software to generate an e-mail or any other means to achieve this goal.

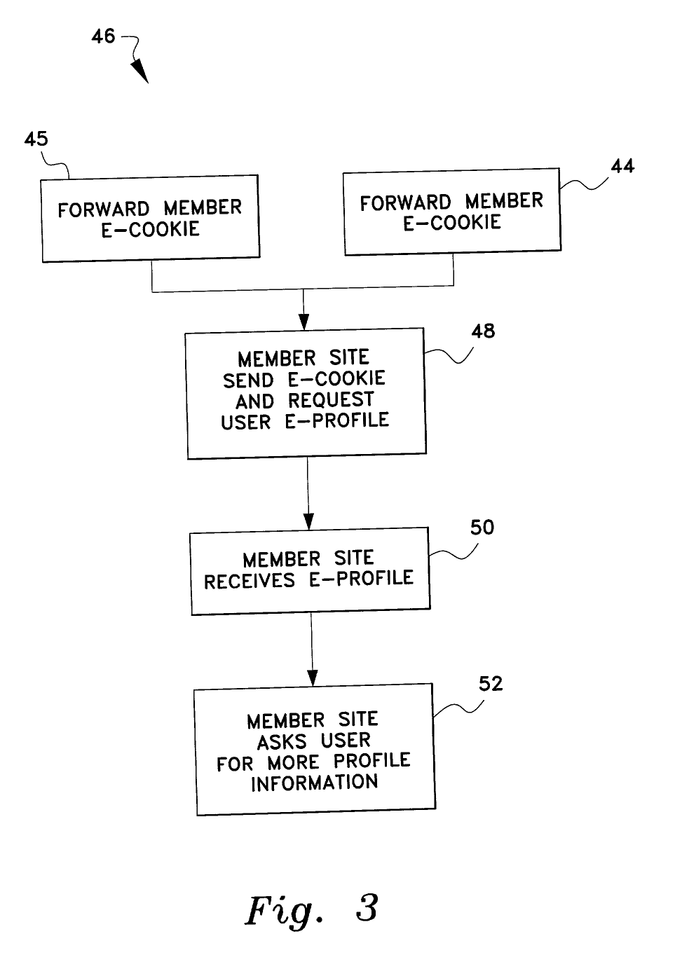

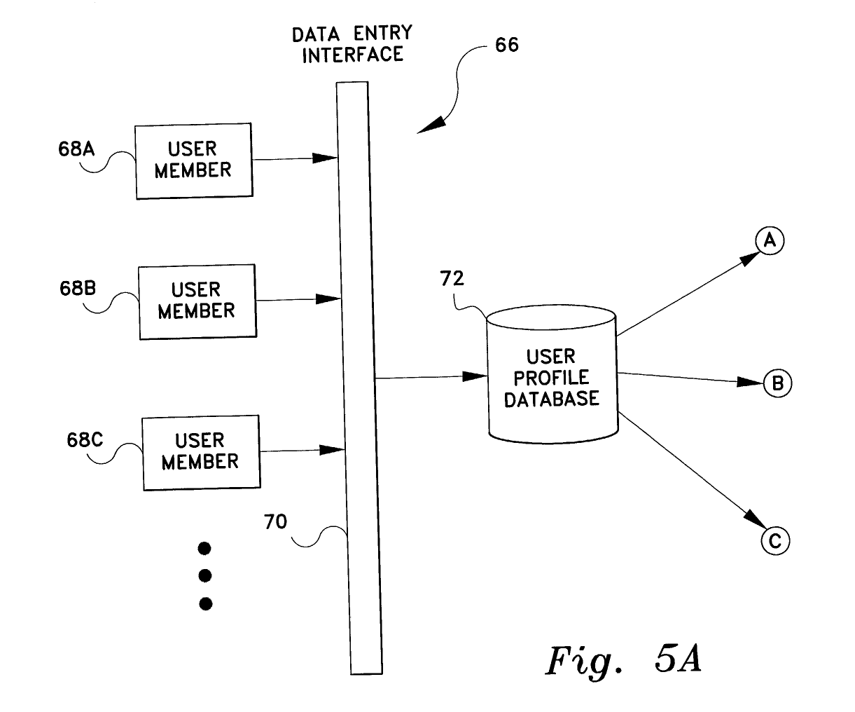

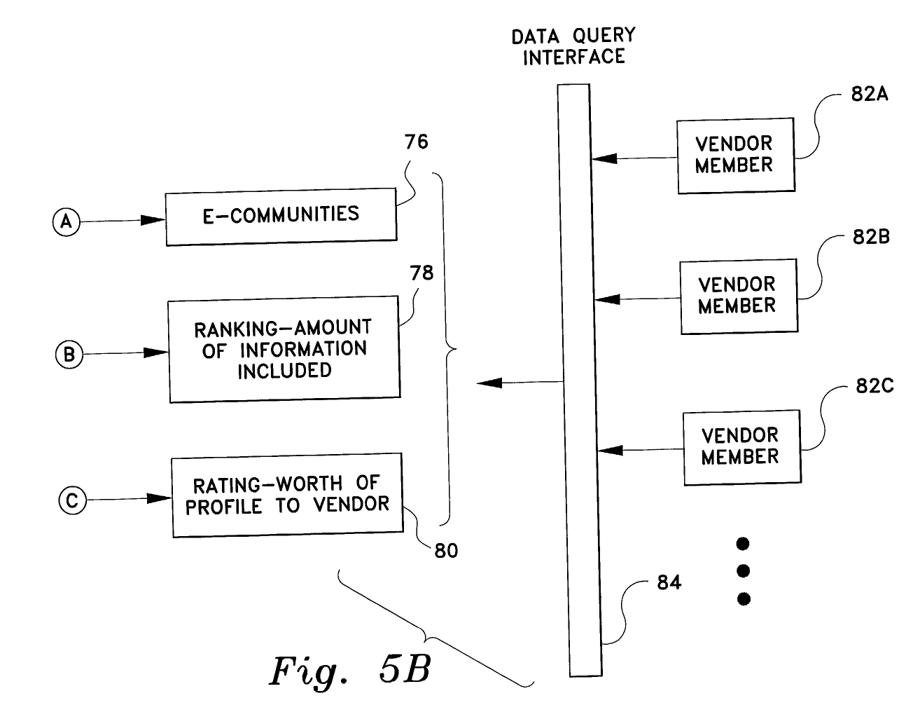

FIG. 3 illustrates the disposition of the forwarded member e-cookie 46. After the member site is forwarded the member e-cookie 44 or the e-cookie is placed on the user's hard drive 45, the site may send the e-cookie (or a unique code provided by the e-cookie) and a request for the summary of the user's e-profile (Consent Profile) 48. The e-profile, which is discussed more fully with reference to FIGS. 5A and 5B, is preferably stored on the e-Privacy site. However, the e-profiles may be stored on individual computers, in which case the request 48 is sent to the individual user's computer rather than the e-Privacy site. Rather than an actual request to the e-Privacy site, the vendor may visit the site and obtain the summary of the user's e-profile which describes the levels the user has designated for that vendor. Any of these methods of obtaining the e-profile can be done in real time, i.e. during the user's session on the vendor's site, or after the session. It is further noted that e-profiles may be included in the initial e-cookie forwarded to the vendor, in which case requesting the e-profile 48 is not necessary.

After the member site receives the summary e-profile 50, the site may choose to ask for additional information 52, i.e. request that the user provide more information in their e-profile. This request will be sent to the e-Privacy software through which the user has created the e-profile. This software through which the user has created the e-profile, known as the means for creating personal data, may be located on the user's computer or on the e-Privacy site, either with or separately from the software known as the means to accept a cookie. It is noted that these two means may be referred to as separate software, each performing a function, or one piece of software performing multiple functions. Alternatively, the request may be sent directly to the user. In any case incentives may be provided by the vendor to the user for this additional information.

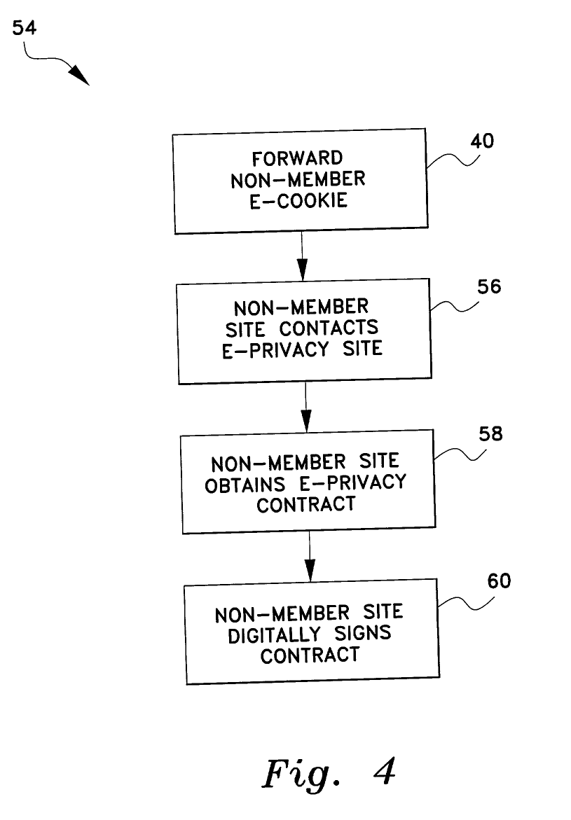

FIG. 4 illustrates the disposition of the forwarded non-member e-cookie 54. The non-member e-cookie may include a message to the non-member vendor stating that their cookie has been removed and advising them that if they want it back, they must join the e-Privacy Network by affirming the e-Privacy contract. The message may also inform the non-member site that cookies sent to other users who are members of the e-Privacy Network will be removed too, but that by joining the network they will establish a relationship with these users.

The message contained in the non-member e-cookie is designed to result in the non-member vendor contacting the e-Privacy site 56 and obtaining an e-Privacy contract 58, i.e. by downloading it from the e-Privacy site, by having a conversation with an e-Privacy Network sales person, or any other known means of delivery and communication. It is contemplated that the non-member e-cookie will include a hypertext link to the e-Privacy site. It is noted that any means to enable the non-member vendor to obtain information is desirable in the present invention.

The sales cycle may include the non-member site digitally signing the contract 60. When the vendor becomes part of the e-Privacy Network, the e-Privacy Network will update the list of vendor members, which is either a part of or can be accessed by software located on the e-Privacy site or on the computers of individual users.

FIGS. 5A and 5B show the creation and the use of the e-profiles 66. User members 68A, 68B, 68C, etc. enter personal profile data through a data entry interface 70 into a user profile database 72. The data entry interface 70, which also allows for adding and editing information, can be any known means for data entry, such as Web-based forms, response to queries by the computer software, or response to queries from member vendors or the e-Privacy Network.

The user member will also be queried to enter their preferences as to their interface with the e-Privacy Network. This Consent Profile will indicate which levels of information can be given to various vendors. For example, a user may not wish financial information given to vendors who typically sell moderately-priced items, such as florists. On the other hand, the user may allow financial information to be given to car dealers and the profile will be established in levels of information, based on these user-defined criteria, guaranteeing this result. The user may also wish to designate the number and frequency of e-mails received from the e-Privacy Network or vendors. The user can also designate which vendors or types of vendors, if any, may receive the user's e-profile in response to an e-community request.

E-communities may include groups of users who share a certain interest and one or more vendors who provide goods or services in that area of interest. For example, those users who play tennis, tennis racket manufacturers, and tennis racket retailers may be in an e-community. This grouping would be beneficial to manufacturers and retailers in that they could easily reach those consumers most interested in new rackets or deals. Consumers would benefit from being aware of these deals and the ability to learn about manufacturers and retailers.

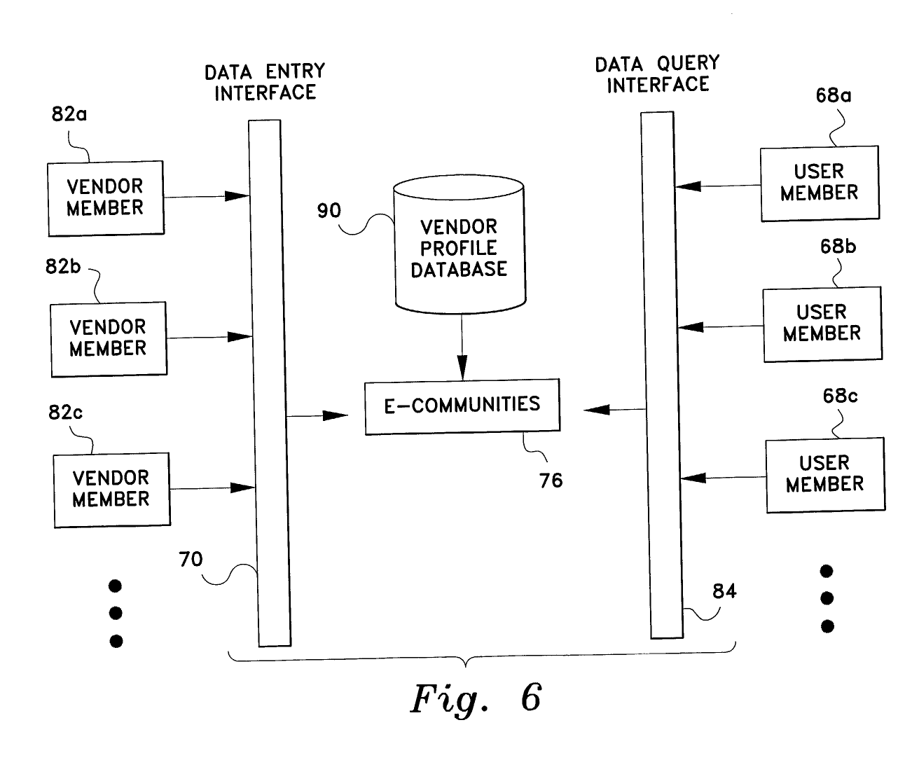

Additionally e-communities may be established by vendors or users. Vendors members 82a, 82b, 82c, etc. may establish these communities based on a query through a data query interface 84 seeking to identify users of certain demographics or other criteria. E-communities may also be created, as shown in FIG. 6 through user requests (through a data query interface 86) for certain types of vendors, e.g. those selling tennis rackets below manufacturer's suggested retail price and in a certain geographic area, etc. Vendor members are provided a data entry interface 88 to provide descriptions of themselves and the information they collect and use is stored in a vendor profile database 90.

These e-profiles allow the e-Privacy Network to create e-communities 76 based on demographic, financial, and preference data. A vendor member, e.g. a Mercedes dealer, may request an e-community 76 of user members having certain characteristics, e.g. those users who have a certain income, live within a certain radius of the dealership, and plan to buy a car within a certain period.

The e-Privacy Network may provide the vendor with a conglomeration of data from various e-profiles meeting the request, which may simply amount to informing the vendor how many users fit the e-community 76 requested by the vendor. For example the network may tell the vendor of other profile characteristics, such as gender, of the user members matching the vendors income, geographic, and car-buying plans requirements. The network may provide the entire e-profile of the user members whose profile indicates they meet the vendor' requirements (only if the user member has previously indicated their willingness to have e-profiles forwarded in response to such requests). The way in which this data is presented to the member vendor may affect the compensation to the e-Privacy Network.

The vendor may request that these users be contacted informing them of the vendor's deal. The users are then contacted, generally by e-mail, by the vendor or by the e-Privacy Network. It is noted that contact by the e-Privacy Network will maintain the anonymity of the user with respect to the vendor, something the user may request. The user may choose to limit the number of e-mails from the e-Privacy Network. The e-Privacy Network will then rank the order of importance to the user of the vendor contact (and offer) and send e-mails based on that ranking. The e-Privacy Network may be compensated by the vendor based on the number of users contacted or based on the transactions resulting from these contacts.

In addition, the e-Privacy Network performs ranking 78 and rating 80 functions. Ranking 78 is based on the amount of information collected, and rating 80 is based on the ways the information is used. The ratings may be used as part of an e-community 76 description.

Additionally, vendors may request additional information from user members, e.g. the Mercedes dealer above may wish to obtain information about the types of cars currently driven by users in its e-community. This request may be sent to the e-Privacy Network and user members will be encouraged by the network to provide this information. These types of vendor requests, which supplement e-community data, are different from vendor requests relating to specific e-profiles, which may be made directly to the user or to the e-Privacy software.

The above description relates to a centralized system for e-profiles. The invention also contemplates the e-profiles being stored on a user's computer 12, in which case the use of the e-communities 76, ranking 78, and rating 80 will require communication between the e-Privacy site and individual computers 12.

It is to be understood that the present invention is not limited to the sole embodiments described above, but encompasses any and all embodiments within the scope of the following claims.

I claim:

1. A method of allowing a user to browse the Web without reducing access and without privacy concerns, comprising:
enabling the user to create a personal profile;
accepting a cookie from Web sites that send cookies;
determining if a site has executed a contract regarding privacy;
making available an electronically-created file to the site, the file containing or enabling the site to access profile information about the user if the site has executed the contract;
removing or hiding the cookie if the site has not executed the contract; and
forwarding an electronically-created file to the site offering the site an opportunity to affirm the contract if the site has not executed the contract.

2. The method of claim 1 wherein said enabling the user to create a profile includes providing Web-based forms or providing software that queries the user.

3. The method of claim 1 wherein said making available is accomplished by forwarding the electronically-created file to the site.

4. The method of claim 1 wherein said making available is accomplished by placing the electronically-created file on a hard drive of the user.

5. The method of claim 1 further comprising:
creating pseudo-cookies for sites that do not send cookies;
keeping track of the cookies and the pseudo-cookies; and
causing a list of the cookies and the pseudo-cookies to be displayed at the request of a user.

6. A method of acting as an intermediary between a user and a Web site, comprising:
providing a contract addressing the privacy of the user to the Web site;
causing the contract to be executed by the Web site.

7. The method of claim 6 further comprising:
providing data entry means to the user so that the user can provide a personal profile; and
providing the personal profile to the Web site if it has executed the contract.

8. The method of claim 7 wherein said providing the personal profile includes providing an electronically-created file to the Web site.

9. The method of claim 8 wherein said providing an electronically-created file includes providing a unique user identifier code to the Web site, which the Web site can use to obtain the personal profile.

10. The method of claim 7 wherein said providing the personal profile to a Web site includes:
receiving a request from the Web site for personal profile data meeting certain requirements; and
providing information to the Web site based on a conglomeration of data from multiple profiles responsive to the request.

11. The method of claim 7 wherein said providing the personal profile to a Web site includes providing a limited amount of data based on user-defined criteria.

12. The method of claim 6 wherein said causing the contract to be executed includes sending a message to the Web site if it has not previously executed the contract.

13. The method of claim 6 wherein said causing the contract to be executed includes:
removing or hiding a cookie sent by the Web site if it has not previously executed the contract; and
sending a message to the Web site informing it that the cookie will not be available until it executes the contract.

14. The method of claim 6 wherein said causing the contract to be executed includes negotiating with the Web site at the outset of the application of the method.

15. A computerized method of insuring the privacy of a user and obtaining personal information about the user, comprising:
executing a contract addressing the privacy of the user;
receiving personal information about the user in exchange for executing the contract.

16. The method of claim 15 wherein said receiving personal information includes:
sending a cookie to the user; and
receiving the personal information or a code to obtain the personal information.

17. The method of claim 15 wherein said receiving personal information includes:
sending a cookie to the user; and
retrieving the personal information or a code to obtain the personal information from a hard drive of the user.

18. The method of claim 15 wherein said receiving personal information includes:
requesting information based on certain demographic and other criteria of users; and
receiving data about the users.

19. A system for protecting the privacy of a user, comprising:
software including:
means to accept a cookie if a site sends a cookie;
means to determine if a site has executed a contract regarding privacy;
means to make available an electronically-created file to sites having executed the contract which contains or enables the site to access profile information about the user;
means to remove or hide the cookie if the site has not executed the contract; and
means to forward an electronically-created file to the site if the site has not executed the contract which contains a message informing the site of the disposition of its cookie and offers the site a chance to execute the contract;
data-entry means which allows the user to enter personal data; and
a user profile database for storing the data.

20. The system of claim 19 wherein said means to make available is means to forward the electronically-created file to the site.

21. The system of claim 19 wherein said means to make available is means to place the electronically-created file on a hard drive of the user.

22. The system of claim 19 further comprising:
means for creating a pseudo-cookie if a site does not send a cookie;
means for keeping track of the cookies and the pseudo-cookies; and
means for causing a list of the cookies and the pseudo-cookies to be displayed at the request of a user.

23. A computer software product having a computer-executable set of instructions for protecting the privacy of a user, comprising:
means to accept a cookie if a site sends a cookie;
means to determine if a site has executed a contract regarding privacy;
means to make available an electronically-created file to sites having executed the contract which contains or enables the site to access profile information about the user;
means to remove or hide the cookie if the site has not executed the contract; and
means to forward an electronically-created file to the site if the site has not executed the contract which contains a message informing the site of the disposition of its cookie, offers the site a chance to execute the contract.

24. The product of claim 23 further including means for allowing a user to input personal data.

25. The product of claim 24 further including means for a vendor to make queries as to user input.

26. The product of claim 24 wherein said means for allowing a user to input is located on one of a personal computer of the user and a centralized site.

27. The product of claim 23 wherein said means to accept a cookie is located on one of a personal computer of the user and a centralized site.

28. The product of claim 23 further including means for allowing a vendor to input information about the vendor or its products.

29. The product of claim 28 further including means for a user to make queries as to vendor input.

30. The product of claim 28 wherein said means for allowing a vendor to input is located on one of the site of the vendor and a centralized site.

31. The product of claim 23 wherein said means to make available is means to forward the electronically-created file to the site.

32. The product of claim 23 wherein said means to make available is means to place the electronically-created file on a hard drive of the user.

33. The product of claim 23 further comprising:
means for creating a pseudo-cookie if a site does not send a cookie;
means for keeping track of the cookies and the pseudo-cookies; and
means for causing a list of the cookies and the pseudo-cookies to be displayed at the request of a user.
